(19) United States
(12) Patent Application Publication
(10) Pub. No.: US 2010/0263552 A1
(43) Pub. Date: Oct. 21, 2010

(54) Specialized pan for boiling lasagna noodles

(76) Inventor: Pennie Hendrickson, Longview, WA (US)

Correspondence Address: LITMAN LAW OFFICES, LTD., PATENT LAW BUILDING, 8955 CENTER STREET, MANASSAS, VA, 20110, US

(21) Appl. No.: 12/662,467

(22) Filed: Apr. 19, 2010

Related U.S. Application Data
(60) Provisional application No. 61/202,897, filed on Apr. 17, 2009.

(51) Int. Cl. A47J 36/00

(52) U.S. Cl. 99/416

(57) ABSTRACT

The specialized pan for boiling lasagna noodles includes a first open-top container adapted to receive an insert therein. An imperforate lid optionally closes the open top of the first container. The insert is a second open-top container having a plurality of compartments, each compartment being adapted to house a single lasagna noodle. Perforated side and end walls surround the compartmented inner volume of the insert. A perforated lid is provided to close the open top of the insert. Handles are disposed on the insert for moving the insert into and out of the first container. A protective foot is disposed on the outer surface of the bottom wall of the first container.

### CROSS-REFERENCE TO RELATED APPLICATION

This application claims the benefit of U.S. Provisional Patent Application Ser. No. 61/202,897, filed Apr. 17, 2009.

### BACKGROUND OF THE INVENTION

1. Field of the Invention

The present invention generally relates to cooking utensils, and more particularly to a specialized pan for boiling lasagna noodles.

2. Description of the Related Art

One of the secrets of preparing lasagna is boiling the lasagna noodles properly. Because of its configuration (long and flat), the lasagna noodle is more difficult to boil properly than other noodles (ziti, macaroni, etc.). If un-separated, the starchy, substantially planar surfaces of the lasagna noodles tend to cling together, preventing the boiling water from thoroughly contacting these surfaces and thereby causing the noodles to be undercooked. Even though the noodles are subsequently layered with meat and/or vegetables and baked, the undercooked noodles never quite acquire the taste and texture desired for a top-notch pan of lasagna. The cooking industry would certainly welcome a utensil that would virtually guarantee that the lasagna noodles would be thoroughly and properly boiled before being assembled with other ingredients into a lasagna pan for baking. Thus, a specialized pan for boiling lasagna noodles solving the aforementioned problems is desired.

### SUMMARY OF THE INVENTION

The specialized pan for boiling lasagna noodles comprises a first open-top container adapted to receive an insert therein. An imperforate lid optionally closes the open top of the first container. The insert is a second open-top container having a plurality of compartments, each compartment being adapted to house a single lasagna noodle. Perforated side and end walls surround the compartment area of the insert. A perforated lid is provided to close the open top of the insert. Handles are disposed on the insert for moving the insert into and out of the first container. A protective foot is disposed on the outer surface of the bottom wall of the first container.

Accordingly, the invention presents a utensil for boiling lasagna noodles that insures that each noodle is properly cooked before assembled with other ingredients in a lasagna-baking pan. The utensil is provided with handle structure for safe and efficient disposition. Made of durable material (preferably metal), the utensil easily withstands the temperatures generated by burner elements. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a specialized pan for boiling lasagna noodles according to the present invention.

FIG. 2 is a side view in section of a specialized pan for boiling lasagna noodles according to the present invention.

FIG. 3 is an exploded, perspective view of the specialized pan for boiling lasagna noodles according to the present invention.

FIG. 4 is an end view of an insert for a second embodiment of a specialized pan for boiling lasagna noodles according to the present invention, the insert having a sliding wall.

FIG. 5 is a side view of a sliding wall for the embodiment of a specialized pan for boiling lasagna noodles of FIG. 4.

Similar reference characters denote corresponding features consistently throughout the attached drawings.

### DETAILED DESCRIPTION OF THE PREFERRED EMBODIMENTS

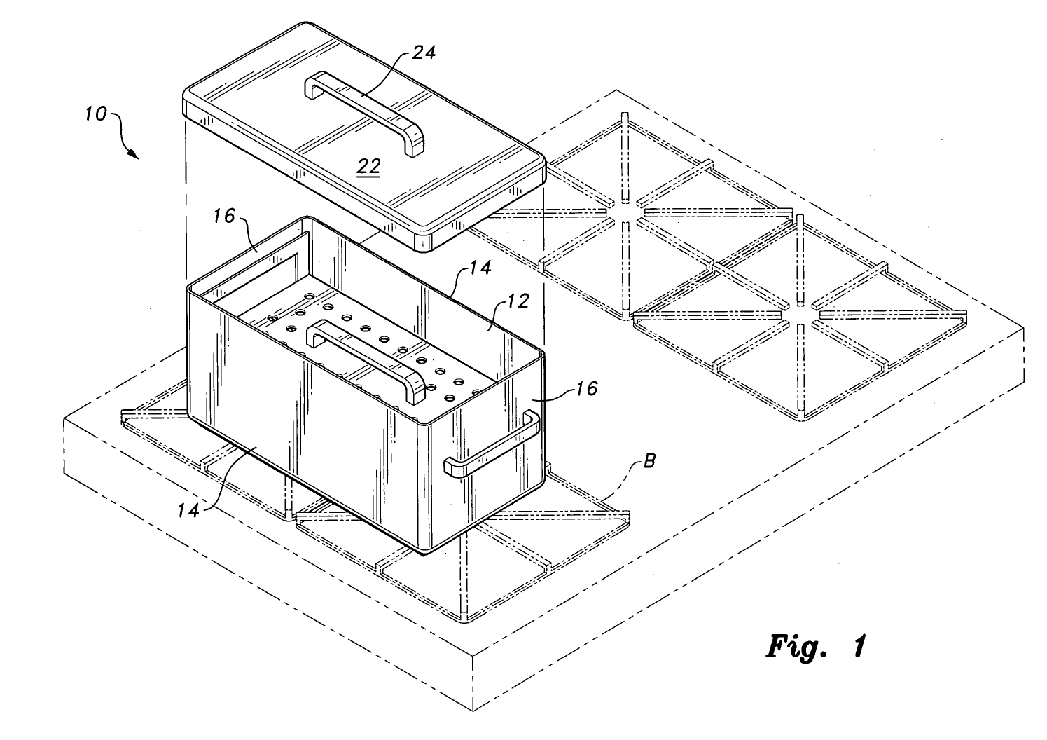

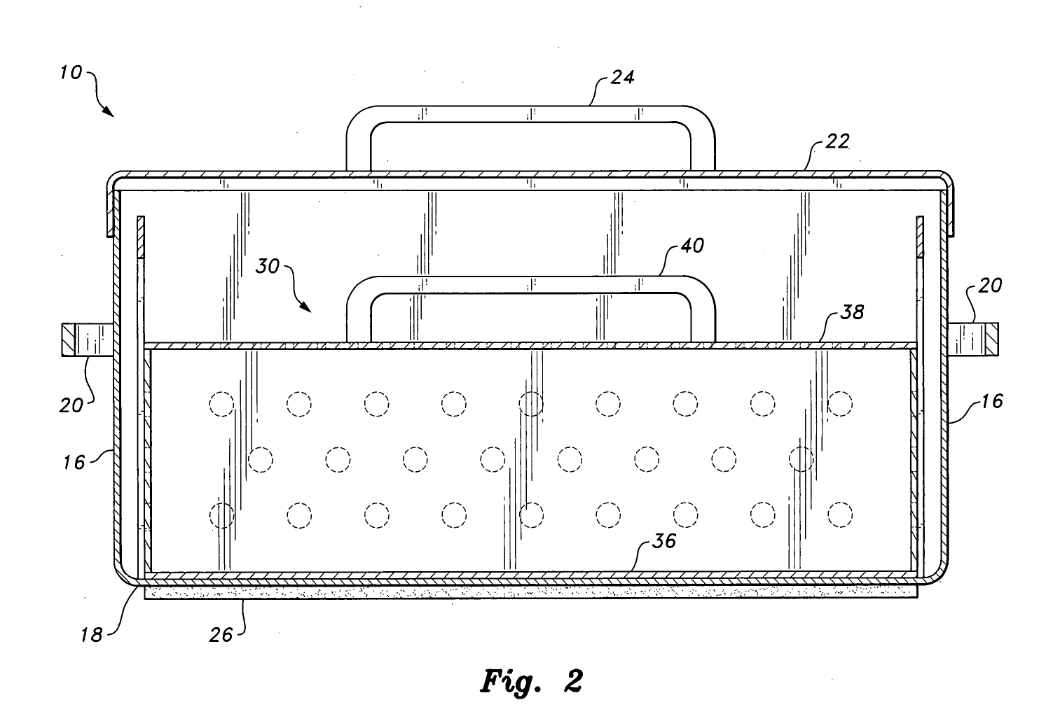

Attention is first directed to FIGS. 1 and 2 wherein the specialized pan for boiling lasagna noodles is indicated generally at 10. Pan 10 comprises a first container having an open top 12, sidewalls 14, end walls 16 and a bottom wall 18. Handles 20 for lifting the container are disposed on end walls 16. A lid 22 having handle 24 thereon is provided to optionally close the open top of the first container. A protective foot member 26 is positioned on the exterior surface of bottom wall 18 and is substantially coextensive therewith. Foot member 26 is adapted to rest upon a burner(s) B. A second open-top container 30 is dimensioned and configured for insertion into the first container.

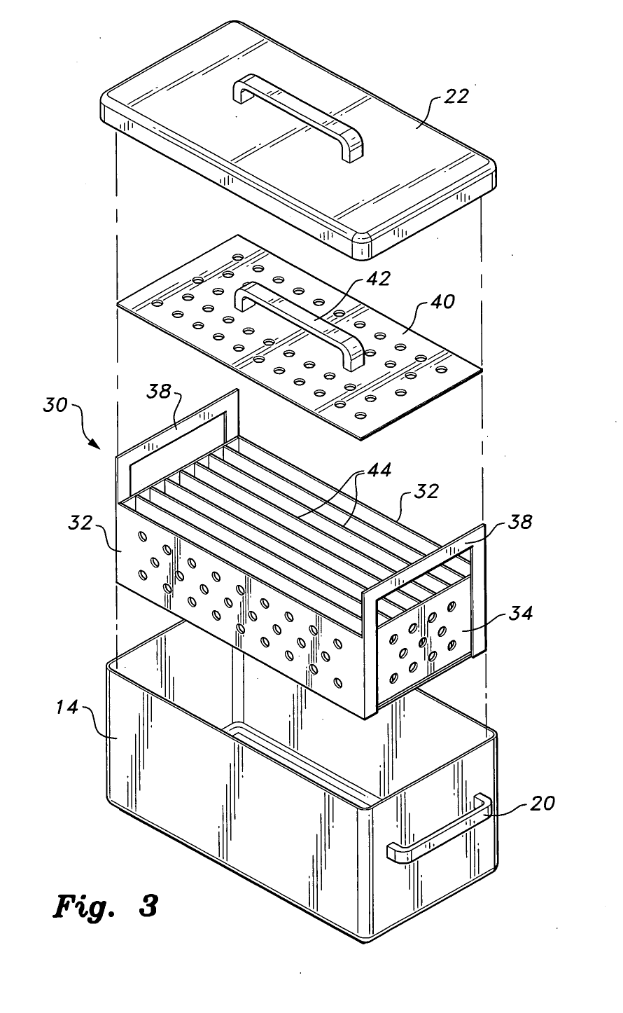

As best seen in FIGS. 2 and 3, second container 30 comprises perforated sidewalls 32, perforated end walls 34 and a non-perforated bottom wall 36. Lifting handles 38 are positioned on end walls 34. A perforated lid 40 having a handle 42 thereon is employed to optionally cover the open top of second container 30. Multiple (non-perforated) partitions 44 are positioned to separate the inner volume of second container 30 into a plurality of compartments. Each compartment is elongated and narrow, being of a length and width to receive a single conventional lasagna noodle placed on edge or vertically therein.

In use, the first container is supplied with a desired amount of water and is placed on the burner(s) B, whereby heat is provided to boil the water. A single lasagna noodle is positioned in each compartment of the second container, and the perforated lid 40 is positioned to cover the open top of the second container. Handles 38 are employed to insert the (lasagna noodle-laden) second container into the boiling water of the first container, and the lid 22 is placed to cover the open top of the first container. The boiling water circulates through the perforated walls and lid of the second container to thoroughly cook the lasagna noodles. The lid 40 of the second container is heavy enough to remain in place and prevent the noodles from floating out of the compartments. When the noodles are cooked to the desired degree, the second container is retrieved from the first container and the noodles removed for further preparation.

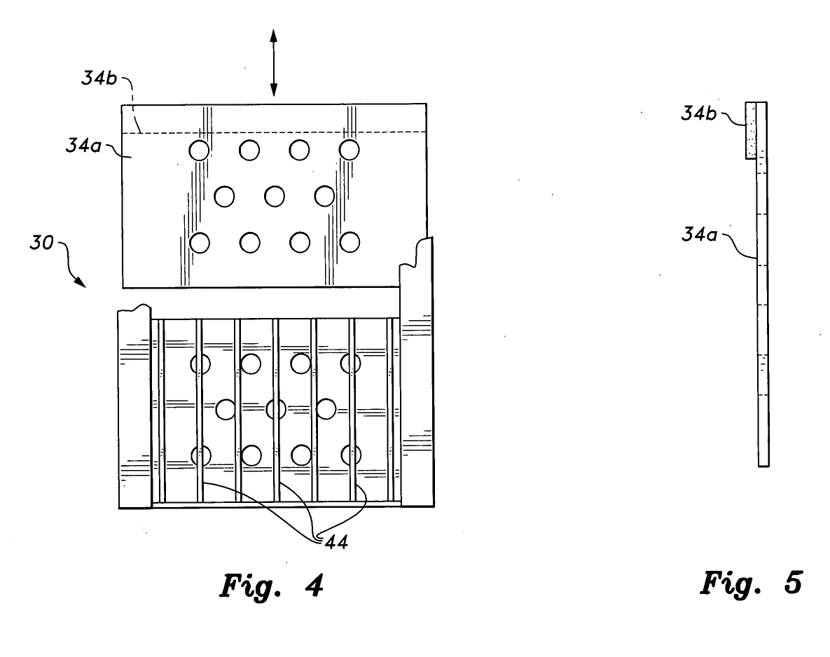

FIGS. 4 and 5 illustrate a second embodiment of the pan 10 wherein at least one end wall 34a is removably mounted in the second container. This arrangement allows a user to easily remove the noodles from the ends of each compartment. End wall 34a is designed with a thickened surface 34b at its upper end to enhance gripping when the wall 34a is being removed or set in place.

It is to be understood that the present invention is not limited to the embodiments described above, but encompasses any and all embodiments within the scope of the following claims.

I claim:

1. A specialized pan for boiling lasagna noodles, comprising:
a first container having end walls, sidewalls, a bottom wall, and an open top joined together to form a pan;
a second container having perforated end walls, perforated sidewalls, an imperforate bottom wall, and an open top joined together to form an insert removably insertable into the first container;
a plurality of partitions disposed in the second container to form a plurality of compartments, each of the compartments being dimensioned and configured to retain a single lasagna noodle placed on edge therein; and
a perforated, removable lid closing the open top of the second container.

2. The specialized pan for boiling lasagna noodles according to claim 1, further including handle members attached to said second container.

3. The specialized pan for boiling lasagna noodles according to claim 1, further comprising a second lid removably covering the first container.

4. The specialized pan for boiling lasagna noodles according to claim 1, wherein at least one of the end walls of said second container is slidably and removably disposed between the sidewalls, whereby cooked lasagna noodles may removed from the second container by removing the slidable and removable end wall and withdrawing the cooked lasagna noodles from their respective compartment by pulling on an end of the noodles.

5. The specialized pan for boiling lasagna noodles according to claim 1, further comprising a foot disposed on the bottom of said first container and extending the length of said first container.

6. A specialized pan for boiling lasagna noodles, comprising:
an elongated pan adapted for boiling water therein;
an elongated insert having perforated, elongated sidewalls, perforated end walls, a solid bottom wall, and a plurality of elongated partition walls extending between the end walls parallel to the sidewalls, the insert defining a container capable of being immersed in the elongated pan, the partition walls defining a plurality of parallel compartments, each of the compartments being dimensioned and configured for receiving a single lasagna noodle therein placed on edge, the partition walls separating the noodles during boiling; and
a perforated cover removably covering the insert to retain the lasagna noodles therein while boiling.

7. The specialized pan for boiling lasagna noodles according to claim 6, further comprising a lid removably covering said pan.

8. The specialized pan for boiling lasagna noodles according to claim 6, further comprising handles formed on the end walls of said insert for lifting said insert out of said pan.

9. The specialized pan for boiling lasagna noodles according to claim 6, wherein at least one of the end walls of said second container is slidably and removably disposed between the sidewalls, whereby cooked lasagna noodles may removed from the second container by removing the slidable and removable end wall and withdrawing the cooked lasagna noodles from their respective compartment by pulling on an end of the noodles.
